(19) United States
(12) Patent Application Publication
(10) Pub. No.: US 2010/0121907 A1
(43) Pub. Date: May 13, 2010

(54) Cooperative Measurement Technique for the Determination of Internet Web Page Exposure and Viewing Behavior

(76) Inventors: Thomas R. McKnight, Ellicott City, MD (US); Lee S. Weinblatt, Teaneck, NJ (US)

Correspondence Address: PROSKAUER ROSE LLP, ONE INTERNATIONAL PLACE, BOSTON, MA, 02110, US

(21) Appl. No.: 12/620,943

(22) Filed: Nov. 18, 2009

Related U.S. Application Data
(63) Continuation-in-part of application No. 12/605,881, filed on Oct. 26, 2009.
(60) Provisional application No. 61/115,904, filed on Nov. 18, 2008.
(60) Provisional application No. 61/108,401, filed on Oct. 24, 2008.

(51) Int. Cl. G06F 15/16

(52) U.S. Cl. 709/202; 709/224

(57) ABSTRACT

Described are a method, a computer program product and apparatus for detecting visual display of content such as web pages. Visual content data encoded with an identifier code is received at a computer device. Visual display data is transmitted, using a local communication bus of the computer device, to a visual display device coupled to the computer device. A processor on the computer device is used to determine whether the visual display data includes the encoded identifier code. Exposure information is generated using the processor. The exposure information is associated with whether the encoded identifier code is included in the visual display data. The exposure information is transmitted, from the computer device, to a remote server device.

### RELATED APPLICATIONS

This application claims priority to and the benefit of U.S. Provisional Patent Application No. 61/115,904, filed on Nov. 18, 2008, and is also a continuation-in-part of U.S. patent application Ser. No. 12/605,881, filed on Oct. 26, 2009, which claims priority to and the benefit of U.S. Provisional Patent Application No. 61/108,401, filed on Oct. 24, 2008, the entire contents of each of which are incorporated herein by reference in their entirety.

### FIELD OF THE INVENTION

The present invention relates to a computer-implemented method, a computer program product and an apparatus for measuring exposure to image and video content, including advertisements.

### BACKGROUND

Advertisements are increasingly being delivered onto personal computers in the form of both video content and static images. Many techniques used in the measurement of individual exposure to computer-delivered content are primarily applied to online advertising and make use of features built into web browsers that recognize external tags associated with the content as part of the web-based content delivery. These tags (e.g., “cookies”) are typically stored on the user's computer by the computer's web browser, and can later be used for a variety of purposes, including the measurement of advertising exposure. When a web browser pulls content from a web site, it makes a record of the individual tagged items which were used to make up the web page and stores this on the computer's hard drive. This information can then be collected from individual web browsers to form an indication of exposure to a specific advertisement from amongst the population of browsers polled. This technique does not determine whether visual content or the web page was actually delivered to the computer's screen (as can happen when a browser window is minimized, or when a portion of a web page is scrolled off-screen) and does not provide any indication whatsoever of the length of time that the advertisement was actually being presented to the viewer. This technique also does not measure what portion of the page was presented to the computer display. Rather, the technique measures that the computer web browser retrieved a given web page and records certain attributes of the content on that particular web page. Further, this technique does not work for certain forms of embedded web content, and does not work at all for content that is not displayed using a web browser (such as stored videos played on media viewers).

### SUMMARY OF THE INVENTION

The present invention overcomes the shortcomings described above by monitoring and analyzing the imagery data that is presented to a user's monitor.

One approach to measuring advertisement exposure of visual content is to encode and decode the visual content with an identifier code. The invention, in one aspect, features a computer-implemented method for detecting visual display of content. The computer-implemented method includes receiving, at a computer device, visual content data encoded with an identifier code. The computer-implemented method also includes transmitting, using a local communication bus of the computer device, visual display data to a visual display device coupled to the computer device. The computer-implemented method also includes determining, using a processor on the computer device, whether the visual display data includes the encoded identifier code. The computer-implemented method also includes generating, using the processor, exposure information associated with whether the encoded identifier code is included in the visual display data. The computer-implemented method also includes transmitting, from the computer device, the exposure information to a remote server device.

In another aspect, there is a computer program product, tangibly embodied in a machine-readable storage device. The computer program product includes instructions being operable to cause a data processing apparatus to receive, at the data processing apparatus, visual content data encoded with an identifier code. The computer program product further includes instructions being operable to cause a data processing apparatus to transmit, using a local communication bus of the data processing apparatus, visual display data to a visual display device coupled to the data processing apparatus. The computer program product further includes instructions being operable to cause a data processing apparatus to determine, using a processor on the data processing apparatus, whether the visual display data includes the encoded identifier code. The computer program product further includes instructions being operable to cause a data processing apparatus to generate, using the processor, exposure information associated with whether the encoded identifier code is included in the visual display data. The computer program product further includes instructions being operable to cause a data processing apparatus to transmit, from the data processing apparatus, the exposure information to a remote server device.

In another aspect, there is a system for detecting visual display of content. The system includes a central processing unit configured to receive visual content data encoded with an identifier code. The central processing unit is also configured to determine whether visual display data includes the encoded identifier code. The central processing unit is also configured to generate exposure information associated with whether the encoded identifier code is included in the visual display data. The central processing unit is also configured to transmit the exposure information to a remote server device. The system also includes a local communication bus, coupled to the central processing unit, configured to transmit the visual display data to a visual display device.

In another aspect, there is a system for detecting visual display of content. The system includes a processing unit configured to receive, from a local communication bus of a computer device, visual display data. The processing unit is also configured to determine whether the visual display data includes visual content data encoded with an identifier code. The processing unit is also configured to generate exposure information associated with whether the encoded identifier code is included in the visual display data. The processing unit is also configured to transmit, from the first computer device, the exposure information to a remote server device.

In other examples, any of the aspects above can include one or more of the following features. In some embodiments, the processor includes a central processing unit of the computer device. In other embodiments, the processor is coupled to the local communication bus and is different from a central processing unit of the computer device. The visual display data can include the visual content data encoded with the identifier code. The visual display data can be generated to include the visual content data by a software application executing on a central processing unit of the computer device. The software application can include a web-based browser application, a video-streaming application, a video-player application, a game application, or any combination thereof. The visual content data can include static images, animated images, video data, or any combination thereof. The visual content data can be received from the Internet. The exposure information can include size information associated with the size of the visual content data in the visual display data, timing information associated with a length of time that the visual content data is included in the visual data, or any combination thereof.

Any of the above implementations can realize one or more of the following advantages. The actual display of the visual content data on a visual display device, such as a computer screen, can advantageously be determined, as opposed to the visual content data being located in a portion of a display window (e.g., web page) that was never scrolled to, or within a minimized display window. The ability to measure the exposure of visual content can advantageously be performed independent of what software application is used to generate or control that the visual display include the visual content data. In some embodiments, measuring visual content exposure can be performed for visual content controlled by browser-based applications and/or non-browser based applications, such as, for example, movie players (streaming or download) and game applications. The size at which the visual content data is displayed (as this can vary depending on how the user has arranged individual application windows) can advantageously be determined. The length of time that the visual content data is displayed can advantageously be determined.

In another aspect, there is a computer-implemented method for detecting visual display of a web page. The computer-implemented method includes receiving, at a computer device, a web page encoded with two or more identifier codes. The computer-implemented method also includes transmitting, using a local communication bus of the computer device, visual display data to a visual display device coupled to the computer device. The computer-implemented method also includes determining, using a processor on the computer device, whether the visual display data includes at least one of the two or more encoded identifier codes. The computer-implemented method also includes generating, using the processor, exposure information associated with whether the two or more encoded identifier codes are included in the visual display data. The computer-implemented method also includes transmitting, from the computer device, the exposure information to a remote server device.

In another aspect, there is a computer program product, tangibly embodied in a machine-readable storage device. The computer program product includes instructions being operable to cause a data processing apparatus to receive, at the data processing apparatus, a web page encoded with two or more identifier codes. The computer program product further includes instructions being operable to cause a data processing apparatus to transmit, using a local communication bus of the data processing apparatus, visual display data to a visual display device coupled to the data processing apparatus. The computer program product further includes instructions being operable to cause a data processing apparatus to determine, using a processor on the data processing apparatus, whether the visual display data includes at least one of the two or more encoded identifier codes. The computer program product further includes instructions being operable to cause a data processing apparatus to generate, using the processor, exposure information associated with whether the two or more encoded identifier codes are included in the visual display data. The computer program product further includes instructions being operable to cause a data processing apparatus to transmit, from the data processing apparatus, the exposure information to a remote server device.

In another aspect, there is a system for detecting visual display of content. The system includes a central processing unit configured to receive visual content data encoded with two or more identifier codes. The central processing unit is also configured to determine whether visual display data includes at least one of the two or more encoded identifier codes. The central processing unit is also configured to generate exposure information associated with whether the two or more encoded identifier codes are included in the visual display data. The central processing unit is also configured to transmit the exposure information to a remote server device. The system also includes a local communication bus, coupled to the central processing unit, configured to transmit the visual display data to a visual display device.

In another aspect, there is a system for detecting visual display of content. The system includes a processing unit configured to receive, from a local communication bus of a computer device, visual display data. The processing unit is also configured to determine whether the visual display data includes a web page encoded with two or more identifier codes. The processing unit is also configured to generate exposure information associated with whether the two or more encoded identifier codes are included in the visual display data. The processing unit is also configured to transmit, from the first computer device, the exposure information to a remote server device.

In other examples, any of the aspects above can include one or more of the following features. In some embodiments, the processor includes a central processing unit of the computer device. In other embodiments, the processor is coupled to the local communication bus and is different from a central processing unit of the computer device. The visual display data can include at least a portion of the web page encoded with one or more of the two or more identifier codes. The visual display data can be generated to include the visual content data by a software application executing on a central processing unit of the computer device. The software application can include a web-based browser application, a video-streaming application, a video-player application, a game application, or any combination thereof. The web page can include two or more visual objects associated with the two or more identifier codes. Vertical and/or horizontal positions of the two or more visual objects can be associated with the two or more identifier codes. The exposure information can include vertical and/or horizontal position information generated based on the associations between the two or more identifier codes and the vertical and/or horizontal positions of the two or more visual objects. The two or more visual objects can include two or more static images, animated images, and/or video data objects. The visual content data can be received from the Internet. The exposure information can include size information associated with the size of the visual content data in the visual display data, timing information associated with a length of time that the visual content data is included in the visual data, or any combination thereof.

Previous systems and techniques used to measure advertising delivered by computer only report on ads downloaded to a computer and do not take into account ads that actually get displayed on screen. Other techniques rely on tracking pages that are visited, and whether there is tagged advertising somewhere on those pages. For example, if an Internet page containing a news story with advertising content is visited, the browser records that the page was visited, and reports all of the tagged advertising content associated with that page. With this technique, there is no way to know what portion of the page that was actually displayed on-screen, and whether or how long any of the ads appeared on-screen.

Other aspects, examples, and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other features and advantages of the present invention, as well as the invention itself, will be more fully understood from the following description of various embodiments, when read together with the accompanying drawings.

FIG. 1 is a block diagram illustrating a computer device for decoding of visual content data, according to an illustrative embodiment of the invention.

FIG. 2 is a flow diagram illustrating encoding and decoding of visual content data, according to an illustrative embodiment of the invention.

FIG. 3 is a flow diagram illustrating encoding and decoding of a web page, according to an illustrative embodiment of the invention.

### DETAILED DESCRIPTION

In one aspect, the invention makes use of an encoder/decoder system whereby visual content data (e.g., static images, animated images, video data, and/or other visual content data) is encoded with an identifier code. For example, visual content data can be encoded with a mark using digital image watermarking. In some embodiments, the identifier code is encoded in a manner that minimizes its visual appearance to the human eye, but still allows the identifier code to be detected by software and/or hardware. In a supplemental or alternative aspect, the invention makes use of an encoder/decoder system whereby a web page(s) is encoded with an identifier code. Encoding of web pages can advantageously provide a technique for the unambiguous measurement of viewing behavior for selected web pages of interest.

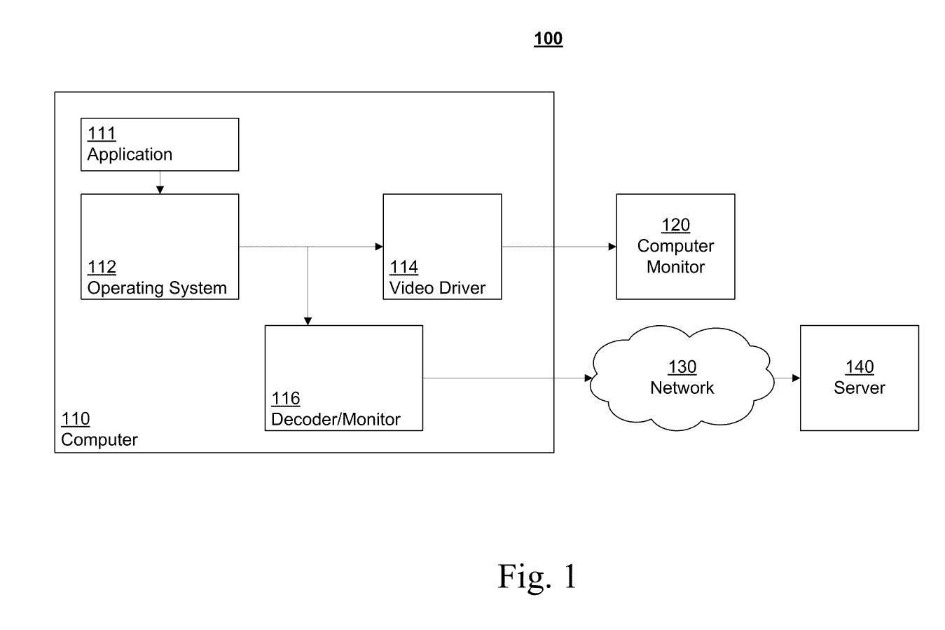

FIG. 1 is a block diagram showing an exemplary system 100 with devices relating to decoding visual content, according to an illustrative embodiment of the invention. The system 100 includes a computer device 110, a visual display device 120, a network 130, and a server 140. The computer device 110 can include an application 111 running on an operating system 112, a video driver 114, and/or a decoder/monitor 116. In some embodiments, the computer device 110 can include a personal computer (e.g., desktop or laptop) or a mobile communications device with a display (e.g., a cell phone, smartphone, and/or the like). The application 111 can include, for example, any application (such as a web browser or gaming application) that provides images to be displayed to the visual display device 120. The operating system 112 can be implemented on a central processing unit of the computer device 110. In some embodiments, the video driver 114 can include a video controller embedded on a motherboard. In alternative or supplemental embodiments, the video driver 114 can include a video card. The video driver 114 can be coupled to the operating system 112 using a local communication bus that transmits visual display data for display on the visual display device 120.

In some embodiments, data sent to the visual display device 120 can be sent in a specific computer display standard including, for example, a Video Graphics Array (VGA) display standard, a Super VGA (SVGA) display standard, an eXtended Graphics Array (XGA) display standard, a Widescreen Extended Graphics Array (WXGA) display standard, a National Television System Committee (NTSC) display standard, an Advanced Television Systems Committee (ATSC) display standard, or any other standard for the presentation of visual content data.

The detector/monitor 116 can be implemented as hardware and/or software on a processing unit separate from the central processing unit (e.g., the operating system 112) of the computer device 110. In this case, the processor that implements function(s) of the detector/monitor 116 can be coupled to the same local communication bus that is used to transmit visual display data to the video driver 114. In alternative or supplemental embodiments, the detector/monitor 116 can be implemented as hardware and/or software on the central processing unit (e.g., the operating system 112) of the computer device 110. In yet further alternative or supplemental embodiments, the detector/monitor 116 can be implemented as hardware and/or software on a processing unit external to the computer device 110, where the processing unit has access to the visual display data transmitted to the video driver 114 and/or the visual display device 120. For example, an external detector/monitor 116 can analyze data transmitted from the operating system 112 via a visual content interface such as a Digital Video Interface (DVI), a VGA connector, a High-Definition Multimedia Interface (HDMI), a Universal Serial Bus (USB), an IEEE 1394 interface, or other physical interface. An external detector/monitor 116 can advantageously operate independent of the computer device 110, the operating system 112, and/or the application 111. In addition, an external detector/monitor 116 advantageously uses little of the computer 110's resources.

In the case of computer-delivered content, the computer device 110 can be a personal computer and the decoder 116 can be in the form of a software application that resides on the personal computer. The software application can monitor all visual display data sent out to the computer's video monitor and analyze that data to detect and/or decode any portion of the visual field which is displayed on the computer screen. The decoder/monitor 116 can then transmit exposure information over the network 130 to a server 140. The network 130 can be, for example, the Internet, a satellite or cable network, a wireless network (e.g., 3G, 4G, WiMax, and/or the like), and/or other communication networks. The server 140 can be a central computer that stores the exposure information. The server 140 can combine the exposure information received from one or more other computer devices (not shown) connected to one or more other networks.

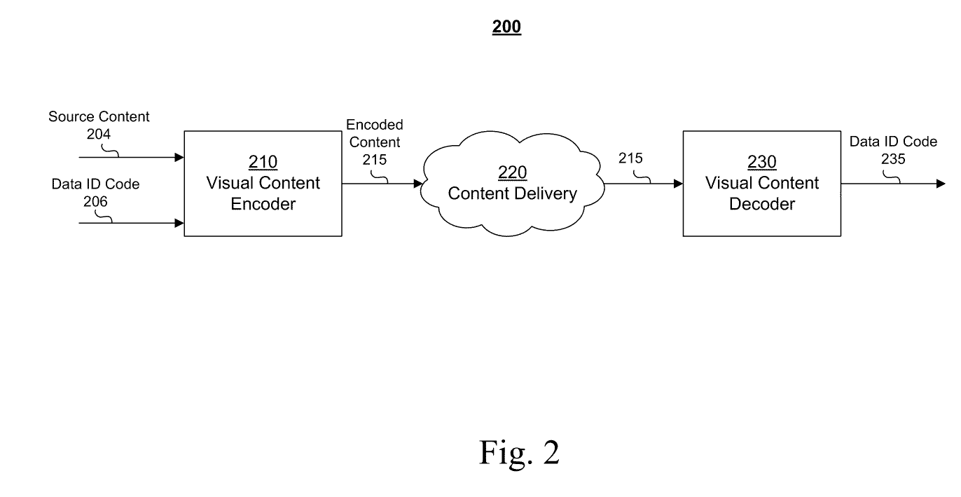

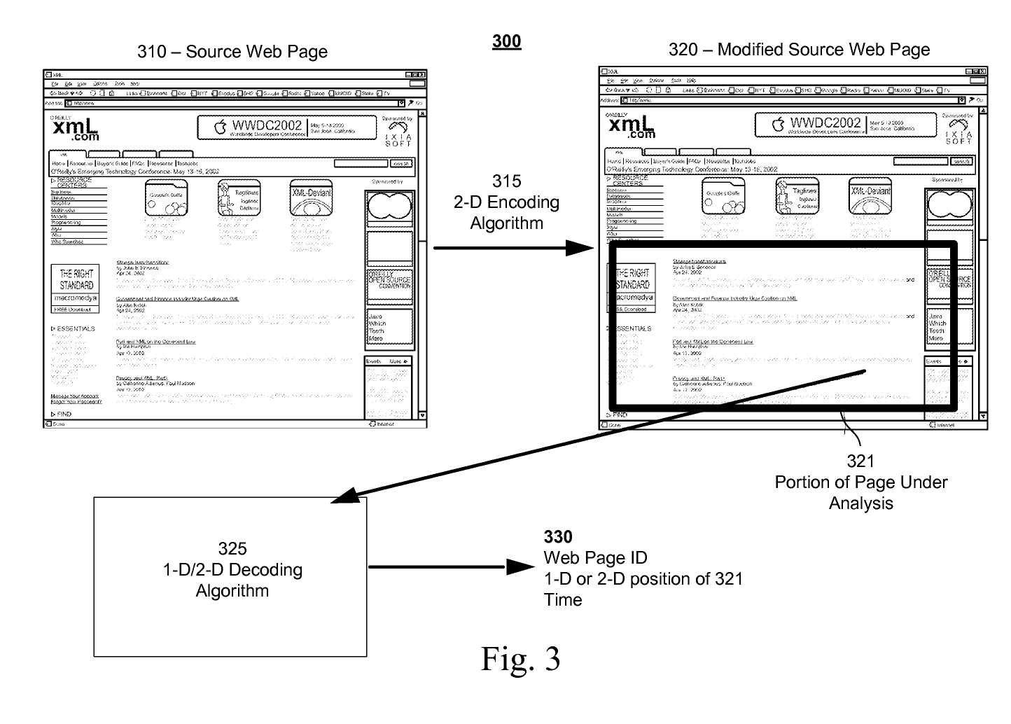

FIG. 2 illustrates a flowchart 200 depicting an implementation of encoding video and/or image content, according to an illustrative embodiment of the invention. The implementation includes encoding source content 204 with a data identifier code 206 (210), delivering the encoded content 215 (220), and decoding the content to obtain the data identifier code 235 (230). In general, source content 204 can include any form of video and/or image content including, but not limited to, content formatted according to the MPEG standard, a streaming video standard, Windows Media Video (WMV), JPEG, Portable Network Graphics (PNG), bitmap (BMP), Graphics Interchange Format (GIF), Tagged Image File Format (TIFF), Audio Video Interleave (AVI), QuickTime, or any combination thereof. In an alternative or supplemental embodiment, as discussed below with respect to FIG. 3, source content 204 can also include web pages.

In some embodiments, the system 100 can be applied to any visual content data delivered to the display device 120. For example, visual content data can include Internet-delivered advertising, ads embedded in video games, downloaded and/or streaming movies, and/or any other application used to display content with advertising. Visual content data can be encoded in a way that minimizes visibility to the human eyes.

Encoding source content 204 with a data identifier code 206 (210) can be accomplished using, for example, a digital image watermarking algorithm. Digital watermarking algorithms generally fall into two categories: spatial-domain techniques (which work with pixel values directly) and frequency-domain techniques (which employ various transforms, either local or global). Digital image watermarking algorithm can be visible or imperceptible. A visible digital watermarking algorithm, for example, can overlay text, a logo, barcode, or other mark on the original visual content. For example, a “masking” algorithm can modify luminance values so as to make a visible pattern on the image. The added mark can be made semi-transparent. An imperceptible digital watermarking algorithm can be performed, for example, using Least-Significant Bit (LSB) insertion, palette sorting, Bit-Plane Complexity Segmentation (BPCS), A Block Complexity based Data Embedding (ABCDE), Spread Spectrum, Image Adaptive Discrete Cosine Transform (IA-DCT), or other well-known digital watermarking algorithms.

LSB insertion includes replacing one or more of the least significant bits of a pixel's luminance, or other measure, with meaningful data (e.g., a data identifier code). Since only the lower-order bits are altered, the resulting color shifts are typically imperceptible. Palette sorting can be applied to image formats, such as GIF, which have each pixel index into a color palette. The color palette is a small subset of the total number of viewable colors. By intelligently reordering the palette, like colors can be arranged to be near each other in index value. Data (e.g., a data identifier code) can then embedded in a similar manner as LSB insertion. Palette sorting can be efficient for grayscale images, which have a narrow range of colors. BPCS includes embedding watermark data (e.g., a data identifier code) only in complex regions of an image. The resulting watermark can be localized on less conspicuous edges and noise-like regions while avoiding regions of flat color. The ABCDE algorithm extends BPCS by adopting a more sophisticated metric for determining the complexity in an image region. The spread spectrum algorithm is a frequency-domain method that takes the DCT transform of the image and adds a series of random values to the high-energy coefficients. These random values form a unique fingerprint that can be used to identify an image (e.g., the unique fingerprint can be associated with the data identifier code). IA-DCT extends spread spectrum by accounting for locally varying image features. Instead of a global DCT, as in spread spectrum, IA-DCT can separate the image into 8×8 tiles and inserts watermark data with a power proportional to the complexity of the tile.

Delivering the encoded content 215 (220) to the computer 110 can include, for example, transmission of the content over the Internet or other computer-based network (e.g., to a personal computer) using a networking communications protocol (e.g., TCP/IP or UDP/IP), over a television network (cable or satellite) (e.g., to a television), over a wireless network (e.g., to a smartphone or other mobile device), or over fixed media (e.g., DVD, BluRay, flash drive, and/or the like).

Once received at the computer device 110, the encoded visual content data can be incorporated into visual display data by the computer device 110 for display onto the display device 120. For example, a personal computer can display the visual content data in a “window,” or a portion thereof, on the visual display device 120. In this case, the visual content data can just be a portion of the overall visual display data sent to the visual display device 120.

Decoding the content to obtain the data identifier code 235 (230) can be accomplished using, for example, a decoding algorithm associated with a particular digital image watermarking algorithm. For visible watermarks, the decoder/monitor 116 can use a binary template matching or normalized correlation method to locate and inspect for one or more known data identifier codes. Binary template and normalized correlation methods involve comparing a training image that contains the pattern to be located with the visual content data. If the degree of match is above a predetermined threshold value, then the pattern can be determined to be included in the visual content data.

For LSB insertion and palette sorting, the decoder/monitor 116 can extract the least-significant bit values from each pixel in the image. For BPCS and ABCDE, the decoder/monitor 116 can analyze the complex regions of the visual content data using, for example, binary template and/or normalized correlation methods. For spread spectrum and IA-DCT, the decoder/monitor 116 can extract the high-energy coefficients of the image. In general, once the decoder/monitor 116 has extracted information from the visual content data, it can determine if the extracted values match one or more predetermined data identifier codes or it can send the extracted values to the server 140.

In some embodiments, the data identifier code 235 can accurately be decoded from the visual display data regardless of any re-sizing of the source visual content data and/or regardless of changes in resolution of the visual content data. In addition, in some embodiments, the data identifier code can be detected even if the source visual content is combined with other visual content, such as is the case on a computer-based delivery system where the coded visual source content is possibly a portion of the visual display data (e.g., a composite image).

The detector/monitor 116 can be configured to listen into data transaction(s) between the operating system 112 and the video driver 114. In this way, the detector/monitor 116 can advantageously function independently of the software application 111 used to generate the visual content/display. The detector/monitor 116 can report detection of encoded content if the encoded identifier is actually transmitted for display on the display or monitor 120, and does not report detection if the visual content data is, from the perspective of the operating system 112, located within a window that is minimized or covered up by another window. In some embodiments, the detector/monitor 116 can continuously monitor and process all of the visual display data that is written out by the operating system 112 to the video driver 114.

The detector/monitor 116 can also provide continuous monitoring of the time and/or duration of exposure of the visual content data, even for static images. For example, once a specific identifier code is decoded, the detector/monitor 116 can add an entry to an internal memory (e.g., a table) with a time. If, at subsequent time intervals, the detector/monitor 116 decodes the same identifier code, it can update the entry in the internal memory to indicate that the identifier code has displayed for the time lapsed since the last decoding step. In alternative or supplemental embodiments, the detection process can also include a measurement of the size and/or resolution that the source visual content data was displayed at. In summary, if a user of the computer device 110 can see encoded visual display data (e.g., including encoded visual content data as an image and/or video) on the display device 120, then the detector/monitor 116 can detect the display of the visual content data. If the user cannot see the encoded visual content data on the display device 120 (e.g., because the encoded visual content data is at the bottom of a web page and the user has not scrolled to the bottom of the webpage), then the detector/monitor 116 can prevent a false detection report of the visual content data from being created.

In some embodiments, the decoder/monitor 116 can identify an individual that is exposed to visual content. For example, the computer device 110 can be a portable wireless device, with a unique device identifier, carried by an individual that can communicate identification information to the decoder/monitor 116. The decoder/monitor 116 can then associate the individual with the detected visual content data.

FIG. 3 illustrates a flowchart 300 depicting an implementation of encoding web pages, according to an illustrative embodiment of the invention. The implementation includes encoding a source web page 310 with a data identifier code (315), delivering the encoded web page 320 to a web browser, and decoding (325) a portion the encoded web page 321 to obtain exposure information 330. The web page can include, for example, HTML web pages, ASP web pages, and/or web pages formatted according to other standards.

In some embodiments, web pages can be encoded by positioning particular images (e.g., advertisements, menu bar images, and/or other images or objects on a web page) along one or more vertical axes, horizontal axes, and/or other axes of the web page. These images can be encoded with different identifiers, using similar algorithms as described above with respect to FIG. 2, that indicate their horizontal and/or vertical position. For example, five images can be positioned vertically on the right side of a web page, where each image has a numerical identifier code that is higher than the one below it (e.g., images 1-5 have codes 01, 02, 03, 04 and 05). In a supplemental or alternative embodiment, the background image can also be encoded with one or more identifier codes that are associated with one or more vertical and/or horizontal positions. By collecting the decoded identifier information of a webpage, the decoder/monitor 116 can determine what portion(s) of a web page was displayed. For example, continuing the illustration given above, if the decoder/monitor 116 detects the two identifiers 04 and 05 associated with the last two images of the five vertical images, then the decoder/monitor 116 can generate information that indicates that the lower portion of the webpage was being displayed. This 1-D vertical positioning algorithm can similarly be extended to 2-D to obtain the horizontal or other axial positions of a web page.

Using one or more of the above-identified techniques, providers of web services, for example, can advantageously encode their web pages and receive exposure feedback information. This information can advantageously be used to measure actual exposure to a web page and/or a portion of a web page as well as to measure a time history of exactly which portion of a web page was viewed by users.

In some embodiments, techniques described above can be used to provide web page viewing exposure and behavior measurement services to corporate clients. For example, corporate clients would pay for the services and would agree to provide access to their web pages of interest so that they could be coded with a 2-D algorithm. In return, the corporate clients would receive viewing exposure and behavior measurements of a panel of users who agree to install a 2-D decoding software application and/or hardware device on their computers.

These viewing exposure and behavior measurements can be provided either separately or in combination with other media exposure and viewing behavior measurements (e.g., television viewing exposure and behavior measurements) from the same or different panels of users.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry® or an iPhone®.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computer-implemented method for detecting visual display of a web page, the computer-implemented method comprising:
receiving, at a computer device, a web page encoded with two or more identifier codes;
transmitting, using a local communication bus of the computer device, visual display data to a visual display device coupled to the computer device;
determining, using a processor on the computer device, whether the visual display data includes at least one of the two or more encoded identifier codes;
generating, using the processor, exposure information associated with whether the two or more encoded identifier codes are included in the visual display data; and
transmitting, from the computer device, the exposure information to a remote server device.

2. The computer-implemented method of claim 1, wherein the processor comprises a central processing unit of the computer device.

3. The computer-implemented method of claim 1, wherein the processor is coupled to the local communication bus and is different from a central processing unit of the computer device.

4. The computer-implemented method of claim 1, wherein the visual display data includes at least a portion of the web page encoded with one or more of the two or more identifier codes.

5. The computer-implemented method of claim 4, wherein the visual display data is generated to include the visual content data by a software application executing on a central processing unit of the computer device.

6. The computer-implemented method of claim 5, wherein the software application comprises a web-based browser application.

7. The computer-implemented method of claim 1, wherein the web page comprises two or more visual objects associated with the two or more identifier codes.

8. The computer-implemented method of claim 7, wherein vertical and/or horizontal positions of the two or more visual objects are associated with the two or more identifier codes.

9. The computer-implemented method of claim 8, wherein the exposure information includes vertical and/or horizontal position information generated based on the associations between the two or more identifier codes and the vertical and/or horizontal positions of the two or more visual objects.

10. The computer-implemented method of claim 7, wherein the two or more visual objects comprise two or more static images, animated images, and/or video data objects.

11. The computer-implemented method of claim 1, wherein the visual content data is received from the Internet.

12. The computer-implemented method of claim 1, wherein the exposure information includes size information associated with the size of the visual content data in the visual display data, timing information associated with a length of time that the visual content data is included in the visual data, or any combination thereof.

13. A computer program product, tangibly embodied in a machine-readable storage device, the computer program product including instructions being operable to cause a data processing apparatus to:
receive, at the data processing apparatus, a web page encoded with two or more identifier codes;
transmit, using a local communication bus of the data processing apparatus, visual display data to a visual display device coupled to the data processing apparatus;
determine, using a processor on the data processing apparatus, whether the visual display data includes at least one of the two or more encoded identifier codes;
generate, using the processor, exposure information associated with whether the two or more encoded identifier codes are included in the visual display data; and
transmit, from the data processing apparatus, the exposure information to a remote server device.

14. A system for detecting visual display of content, the system comprising:
a central processing unit configured to:
receive visual display data encoded with two or more identifier codes;
determine whether visual display data includes at least one of the two or more encoded identifier codes;
generate exposure information associated with whether the two or more encoded identifier codes are included in the visual display data;
transmit the exposure information to a remote server device; and
a local communication bus, coupled to the central processing unit, configured to transmit the visual display data to a visual display device.

15. A system for detecting visual display of content, the system comprising:
a processing unit configured to:
receive, from a local communication bus of a computer device, visual display data;
determine whether the visual display data includes a web page encoded with two or more identifier codes;
generate exposure information associated with whether the two or more encoded identifier codes are included in the visual display data; and
transmit, from the first computer device, the exposure information to a remote server device.
